(19) United States
(12) Patent Application Publication
(10) Pub. No.: US 2024/0394623 A1
(43) Pub. Date: Nov. 28, 2024

(54) Multi-Product Inventory Assortment and Allocation Optimization

(71) Applicant: Oracle International Corporation, Redwood Shores, CA (US)

(72) Inventors: Recep Yusuf BEKCI, Montreal (CA); Andrew VAKHUTINSKY, Sharon, MA (US); Saraswati YAGNAVAJHALA, Johns Creek, GA (US)

(21) Appl. No.: 18/321,831

(22) Filed: May 23, 2023

(51) Int. Cl. G06Q 10/0631; G06Q 10/04

(52) U.S. Cl. CPC G06Q 10/06315; G06Q 10/04

(57) ABSTRACT

Embodiments optimize inventory assortment and allocation of a group of products, where the group of products are allocated from a plurality of different warehouses to a plurality of different retail stores. Embodiments receive historical sales data for the group of products and estimate demand model parameters of a demand model that models a demand of the group of products. Embodiments solve an optimization problem for the inventory assortment and allocation of the group of products, the optimization including a plurality of decision variables, an objective function, and a corresponding Lagrangian relaxation. The solving to generate an optimized solution includes determining a gradient of the objective function with respect to the decision variables, updating the decision variables based on a direction of the gradient and updating dual lambda variables of the Lagrangian relaxation.

### FIELD

One embodiment is directed generally to a computer system, and in particular to inventory assortment and allocation optimization using a computer system.

### BACKGROUND INFORMATION

Inventory allocation to retail stores optimization is a complex problem that involves determining the optimal distribution of inventory across multiple stores to maximize sales, minimize stockouts, and minimize inventory holding costs. There are several factors to consider when optimizing inventory allocation, such as demand forecasting, lead times, store locations, and store size. The problem becomes even more complex and difficult when multiple warehouses can provide inventory to multiple different retail stores, and when multi-product assortments are considered.

### SUMMARY

Embodiments optimize inventory assortment and allocation of a group of products, where the group of products are allocated from a plurality of different warehouses to a plurality of different retail stores. Embodiments receive historical sales data for the group of products and estimate demand model parameters of a demand model that models a demand of the group of products. Embodiments solve an optimization problem for the inventory assortment and allocation of the group of products, the optimization including a plurality of decision variables, an objective function, and a corresponding Lagrangian relaxation. The solving to generate an optimized solution includes determining a gradient of the objective function with respect to the decision variables, updating the decision variables based on a direction of the gradient and updating dual lambda variables of the Lagrangian relaxation.

### BRIEF DESCRIPTION OF THE DRAWINGS

Further embodiments, details, advantages, and modifications will become apparent from the following detailed description of the embodiments, which is to be taken in conjunction with the accompanying drawings.

FIG. 1 is a block diagram of an example retail chain with multiple warehouses and multiple retail stores in the form of physical retail stores.

FIG. 2 is a block diagram of a computer server/system in accordance with an embodiment of the present invention.

FIG. 3 illustrates a hierarchical model in accordance to embodiments.

FIG. 4 illustrates the allocation problem in accordance to embodiments.

FIG. 5 illustrates an example of solutions for the allocation optimization problem for three products by changing inventory levels of two products in accordance to embodiments.

FIG. 6 is a flow diagram of the functionality of the inventory allocation optimization module of FIG. 2 in accordance with one embodiment.

FIG. 7 is an overview diagram of elements of an inventory and transportation monitoring network/system that can implement embodiments of the invention.

FIG. 8 illustrates the entities/sub-entities that may form a planned trip in accordance to embodiments.

FIG. 9 is a block diagram of a gateway architecture in accordance to embodiments of the invention.

### DETAILED DESCRIPTION

One embodiment is a multi-product inventory allocation system that optimizes inventory allocation to multiple physical stores from multiple warehouses with the objective to maximize the revenue subject to the inventory available at the warehouses. It is assumed that the products/items are seasonal (e.g., winter fashion items) and they are removed from all stores at the end of their selling horizon of T weeks. Embodiments include two stages: demand model parameter estimation based on the historical observations, and inventory allocation optimization. At the first stage, a Hierarchical Hamiltonian Monte-Carlo (“HHMC”) approach is used to estimate the parameters. At the second stage, an iterative model is employed using Lagrangian multipliers to penalize inventory constraint violations.

Embodiments decide inventory allocation levels for a set of substitutable products in a retail environment that includes one or more warehouses and multiple stores. The goal is to determine the allocation levels for each product/item at each store subject to the warehouse inventory constraints that would maximize the total revenue or profit within a certain sales period. Since demand patterns are different across the stores and the demand for each product depends on the presence of other products due to the demand transference effect, finding the optimal the solution is not computationally tractable even for a problem of moderate size.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Embodiments are directed to a system or method that maximizes the profit or revenue for a retail chain operating multiple retail stores/locations supplied from multiple warehouses. Each warehouse can serve multiple stores and each store can be supplied from multiple warehouses.

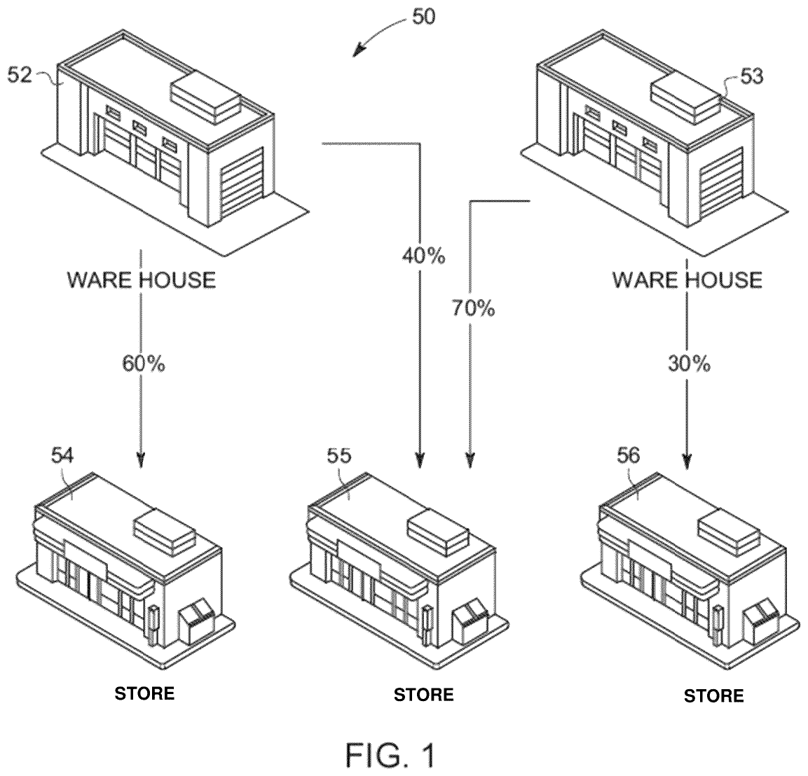

FIG. 1 is a block diagram of an example retail chain 50 with multiple warehouses 52, 53 and multiple retail stores 54-56 in the form of physical retail stores. An inventory allocation for an item from each warehouse to each store can be as shown in FIG. 1, where from warehouse 52, 60% of the item is sent to store 54 and 40% of the item is sent to store 55, and from warehouse 53, 70% of the item is sent to store 55 and 30% of the item is sent to store 56. However, embodiments can be implemented with any number of warehouses, and any number of stores.

In embodiments, at each store, it is assumed that the retailer offers an assortment of products/item, which constitutes a set of partially substitutable products. The products in the assortment are usually of different styles that may include multiple colors and sizes. After an initial procurement and delivery to the warehouses 52, 53, the retailer must decide the composition of product assortment at each store 54-56 and the size of the inventory to account for the demand pattern and substitution effects. Embodiments forecast each product demand and estimates the demand transference within the assortment.

In embodiments, it is assumed that each product style is sold for a limited time, after which it must be cleared from the store. If the product is sold out before its end of life, some revenue is lost. On the other hand, if the product is overallocated to the store, the presence of excessive inventory leads to the clearance at potentially deep discounts, which also results in revenue loss.

Embodiments of the invention are directed in particular to items with a limited life cycle, such as fashion merchandise or electronics. These items lose nearly all their value after a certain amount of time as they have to be replaced by the new version of the product. When such an item approaches its end of life, its inventory is usually not replenished. If the inventory level at the beginning of the period is high enough that it cannot be sold by the exit date at its current price, a markdown is applied.

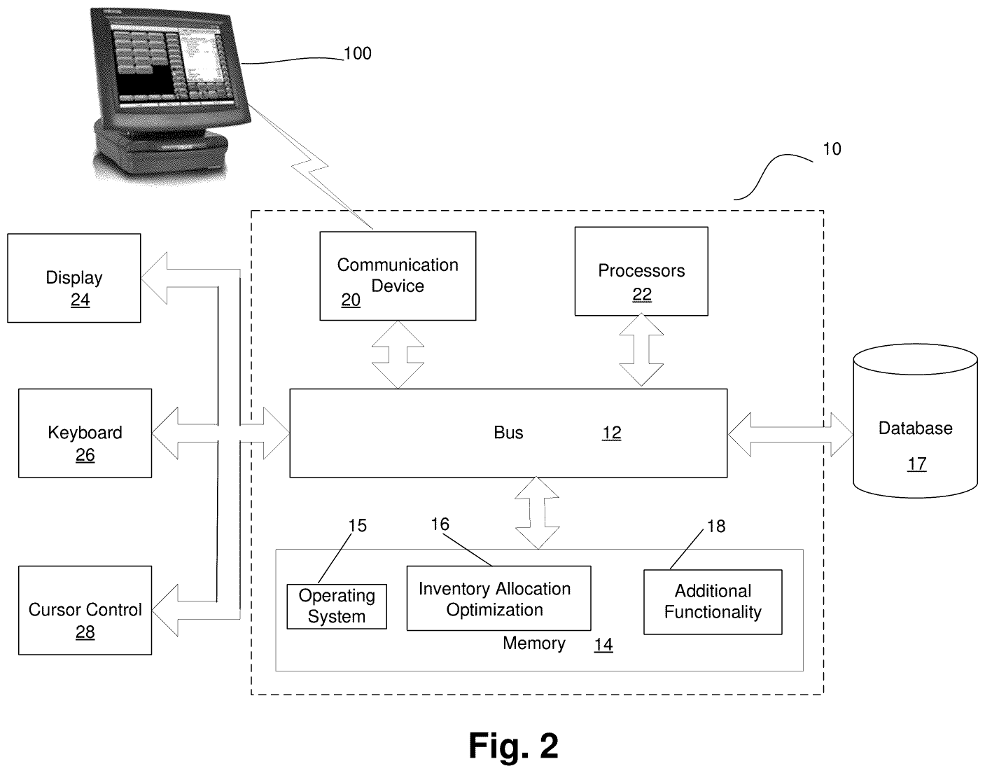

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. System 10 is coupled to one or more of the entities of FIG. 1 (e.g., via a cloud infrastructure) to both receive information (e.g., inventory and sales information) and transmit information (e.g., an inventory allocation signal which specifies how inventory is to be allocated among the stores).

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an inventory allocation optimization module 16 that optimizes inventory allocation from a plurality of warehouses to a plurality of retail stores, and all other functionality disclosed herein. System 10 can be part of a larger system. Therefore, system 10 can include one or more additional functional modules 18 to include the additional functionality, such as a retail management system (e.g., the “Oracle Retail Offer Optimization Cloud Service” or the “Oracle Retail Advanced Science Engine” (“ORASE”) from Oracle Corp.) or an enterprise resource planning (“ERP”) system or inventory management system. A database 17 is coupled to bus 12 to provide centralized storage for modules 16 and 18 and store customer data, product data, transactional data, etc. In one embodiment, database 17 is a relational database management system (“RDBMS”) that can use Structured Query Language (“SQL”) to manage the stored data. In one embodiment, a specialized point of sale (“POS”) terminal 100 generates transactional data and historical sales data (e.g., data concerning transactions of each item/SKU at each retail store) used for inventory allocation optimization. POS terminal 100 itself can include additional processing functionality to optimize inventory allocation in accordance with one embodiment and can operate as a specialized inventory allocation optimization system either by itself or in conjunction with other components of FIG. 2.

In one embodiment, system 10 is a computing/data processing system including an application or collection of distributed applications for enterprise organizations, and may also implement logistics, manufacturing, and inventory management functionality. The applications and computing system 10 may be configured to operate with or be implemented as a cloud-based networking system, a software-as-a-service (“SaaS”) architecture, or other type of computing solution.

### Demand Model

Embodiments initially generate a demand model for each of the products/items that will be allocated from the warehouses to the stores. In general, a demand model for a retail item is a statistical and analytical tool used to estimate the level of consumer demand for a particular product or category of products sold in a retail environment. The model typically takes into account various factors such as price, product features, consumer demographics, and external market conditions to predict how much of a product is likely to be purchased by customers at various price points. Based on historic sales observations of partially substitutable products, embodiments generate the “best” model to predict demand for each product at each store for the given product assortment.

The following notation is used in the demand model in embodiments:
dᵢₜ=demand for the specific product item i or a group of items at time period t;
pᵢₜ=average sales price at period t;
b_{At}=change in the performance of the assortment A at time t;
d̅ᵢ̅ and p̅ᵢ̅ denote average demand and price for a product or group of products.

Consider a log-linear demand model assuming linear dependency on logarithm of the demand on seasonality, price, and assortment effect:

$$\frac{{d}_{it}}{{\overline{d}}_{l}} \sim exp ( {β}_{0} + {\sum }_{w = 1}^{51} {β}_{w} * I ( w = t ) + {β}_{price} \frac{{p}_{it}}{\overline{{p}_{l}}} + {β}_{cannib} {b}_{At} ) \qquad ( 1 )$$

In the model (1), the time periods are weeks, and coefficients β_{w}, w=1, . . . , 51 are multiplicative weekly lift coefficients relative to the arbitrarily selected week 0. β₀ is the intercept of the model that can also be interpreted as base demand at week 0. β_{price} is the price sensitivity coefficient, which is also equal to price elasticity at price p̅ᵢ̅. β_{cannib} is the coefficient expressing the change in demand due to the product cannibalization caused by the change in the assortment.

The change of assortment performance, b_{At}, is defined as follows:

$${b}_{At} = \frac{{z}_{A} ( t ) - \overline{{z}_{A}}}{\overline{{z}_{A}}} \qquad ( 2 )$$

where

$${z}_{A} ( t ) = {\sum }_{i ∈ A} {u}_{it}$$

$$and$$

$${u}_{it} = exp ( {β}_{0} + {\sum }_{w = 1}^{51} {β}_{w} * I ( w = t ) + {β}_{price} \frac{{p}_{it}}{\overline{{p}_{l}}} )$$

The average assortment

$$\overline{{z}_{A}} = \frac{1}{T} {\sum }_{t = 1}^{T} {z}_{A} ( t )$$

can be interpreted as a constant normalizing coefficient.

The last term of the model (1) can be represented as an approximation to the multinomial logit (“MNL”) demand model. Applying approximation

$${e}^{x} \approx \frac{1}{1 - x}$$

to the last term in (1) and using expression for uᵢₜ, results in:

$$\frac{{d}_{it}}{{\overline{d}}_{l}} \sim \frac{{u}_{it}}{1 - {β}_{cannib} \frac{{z}_{A} ( t ) - \overline{{z}_{A}}}{\overline{{z}_{A}}}} = \frac{\overline{{z}_{A}}}{- {β}_{cannib}} \frac{{u}_{it}}{\frac{1 + {β}_{cannib}}{- {β}_{cannib}} + {\sum }_{i ∈ A} {u}_{it}} \qquad ( 3 )$$

For −1<β_{cannib}<0, the first fraction in right-hand side of (3) can be interpreted as the size of the market, and the first term in the denominator of the second fraction,

$$\frac{1 + {β}_{cannib}}{- {β}_{cannib}} ,$$

can be interpreted as the ratio of the uncaptured part of the market, or no-purchase option share, to the captured part of the market. The latter can be also interpreted as the odds ratio of no-purchase to purchasing from the assortment.

### Demand Transference

Following the MNL model terminology, log uᵢₜ is called product i utility at time t. According to the MNL model (3) and its approximation (1), when the utility of the product is increased by Δᵢₜ either due to its discount or simply its introduction into the assortment, approximately −β_{cannib}Δᵢₜ is cannibalized by transferring the demand to other products and (1+β_{cannib})Δᵢₜ increase in demand is transferred from the outside market. In other words, the smaller |β_{cannib}|, the less saturated the market is, and the greater share of demand is coming from the outside market compared with other products.

### Similarity-Based Model Enhancement

If the inter-item similarities are known, then model (1) is modified by making the assortment effect b_{At} item-specific accounting for the effect of each other item on the given item based on their pairwise similarities.

More specifically, let sᵢⱼ be the similarity measure between items i and j provided as part of the input, sᵢⱼ>0. Then expression (2) for the change in utility becomes specific for item j as follows:

$${b}_{Ajt} = \frac{{z}_{Aj} ( t ) - \overline{{z}_{AJ}}}{\overline{{z}_{AJ}}}$$

where the item-specific utility is

$${z}_{Aj} ( t ) = \frac{{\sum }_{i ∈ A \backslash \{ j \}} {s}_{ij} {u}_{it}}{{\sum }_{i ∈ A \backslash \{ j \}} {s}_{ij}}$$

$$and$$

$$\overline{{z}_{{A}_{J}}} = \frac{1}{T} {\sum }_{t = 1}^{T} {z}_{Aj} ( t )$$

Finally, the demand model (1) becomes

$$\frac{{d}_{it}}{{\overline{d}}_{l}} \sim exp ( {β}_{0} + {\sum }_{w = 1}^{51} {β}_{w} * I ( w = t ) + {β}_{price} \frac{{p}_{it}}{{\overline{p}}_{l}} + {β}_{cannib} {b}_{Ait} )$$

### Broken Assortment Effect

The broken assortment effect occurs when the merchandise item is composed of several specific items. For example, a sales item is modeled at the style level which may combine several sub-items of specific size and color. As the combined item sales are progressing without replenishments, some sub-items may run out of stock resulting in the detrimental effect on the total sales of the item. To account for this effect, an assortment level variable aᵢₜ is added to the model expressing the ratio of the current assortment to the full assortment and the model becomes:

$$\frac{{d}_{it}}{{\overline{d}}_{l}} \sim exp ( {β}_{0} + {\sum }_{w = 1}^{51} {β}_{w} * I ( w = t ) + {β}_{price} \frac{{p}_{it}}{{\overline{p}}_{l}} + {β}_{cannib} {b}_{Ait} + {β}_{assort} {a}_{it} )$$

### Model Estimation

The demand model in embodiments is estimated using a hierarchical approach by grouping the sales data of specific styles by merchandise and location hierarchies. Each individual observation is the sales per style per week per store. The stores are grouped by the geographic area (i.e., price zones), while styles are grouped by merchandise categories. The seasonality coefficients (i.e., weekly lifts) are estimated as common for all styles and stores. The price coefficient is estimated per style and geographic region. The cannibalization coefficient is estimated per category and store.

In one embodiment, a Hierarchical Hamiltonian Monte-Carlo (“HHMC”) approach is used to estimate the parameters. HHMC is a variant of Hamiltonian Monte Carlo (“HMC”) that is designed to sample from complex hierarchical models. In HMC, a Hamiltonian system is defined by a potential energy function and a kinetic energy function, and samples are obtained by simulating trajectories through the space of possible configurations using Hamilton's equations. HHMC extends this approach by allowing for multiple levels of hierarchy in the model, where the parameters at each level may have their own distributions and dependencies.

HHMC uses a series of Hamiltonian systems that operate at different levels of the hierarchy, with the trajectories of the lower-level Hamiltonian systems conditioned on the outputs of the higher-level systems. This allows HHMC to efficiently explore the parameter space of complex hierarchical models, where the dependencies between parameters can be difficult to capture with other sampling methods.

In other embodiments, instead of using HHMC, any other models/methods in the family of Markov chain Monte Carlo (“MCMC”) can be used to estimate demand parameters in the hierarchical demand model.

### Observed Data

In embodiments, the observed data, such as what is obtained from POS 100 of FIG. 2, includes integer-valued sales data dₛₗₜ ∈{0, 1, 2, . . . } expressing total sales for all items of style s at store l during week t at price pₛₗₜ when the on-hand inventory level is positive. A zero-inflated Poisson model is assumed, which can be expressed as follows:

Denote the base sales rate of style-location item se at time t as

$${λ}_{s ℓ t} = {\overline{d}}_{s ℓ} exp ( {β}_{0} + {\sum }_{w = 1}^{51} {β}_{w} * I ( w = t ) + {β}_{price}^{s} \frac{{p}_{s ℓ t}}{\overline{{p}_{s ℓ}}} + {β}_{cannib}^{ℓ} {b}_{A ℓ t} + {β}_{assort}^{s} {a}_{s ℓ t} )$$

$$Then :$$

$$P ( {y}_{s ℓ t} \vert θ , λ ) = \{ \begin{matrix}{θ}_{s ℓ} + ( 1 - {θ}_{s ℓ} ) Poisson ( 0 \vert {λ}_{s ℓ t} ) & if {y}_{it} = 0 \\ ( 1 - {θ}_{s ℓ} ) Poisson ( {y}_{s ℓ t} \vert {λ}_{s ℓ t} ) & if {y}_{s ℓ t} > 0\end{matrix}$$

The above model is zero-inflated Poisson distribution where the probability of drawing zero is parameterized as θₛₗ and the probability of drawing from Poisson (λₛₗ) is 1-θₛₗ, which are specific for each item and location. Seasonality parameters β_{w} are assumed to be the same for all styles in the merchandise category and stores in the region or price zone, while price sensitivity parameters β_{price}^{s} and assortment parameters βₐₛₛₒᵣₜ^{s} are common for all stores but may differ among styles and cannibalization coefficients β_{cannib}^{l} may differ for all stores but are common for the styles sold at the same store. Therefore, the Bayesian priors for the estimated parameters are set so that the parameters for the same group are drawn from the distributions whose hyperparameters are drawn from the same “meta” distribution. Embodiments implement the following Bayesian priors:
αₛₗ˜Beta(2,2)
βw˜ [symbol] (0,10)
β_{price}^{s}˜−Gamma(2, α_{price})
βₐₛₛₒᵣₜ^{s}˜Gamma(2, αₐₛₛₒᵣₜ)
β_{cannib}^{l}˜-Beta(α_{cannib}^{low}, α_{cannib}^{high}).
α_{price}˜Cauchy (0,2.5)
αₐₛₛₒᵣₜ˜Cauchy(0,2.5)
α_{acannib}^{low}˜Cauchy(0,2.5)
α_{acannib}^{high}˜Cauchy(0,2.5)

The above Bayesian priors reflect certain features of the model structure and constraints implied by the domain knowledge, specifically:
0<θₛₗ<1
β_{price}^{s}<0
βₐₛₛₒᵣₜ^{s}>0
−1<β_{cannib}^{l}<0

The hierarchically estimated parameters β_{price}^{s}, βₐₛₛₒᵣₜ^{s}, and β_{cannib}^{l} are drawn from the parameterized priors. The estimated parameters of their prior distributions reflect their similarity. The prior distribution parameters are drawn from the weekly informative priors.

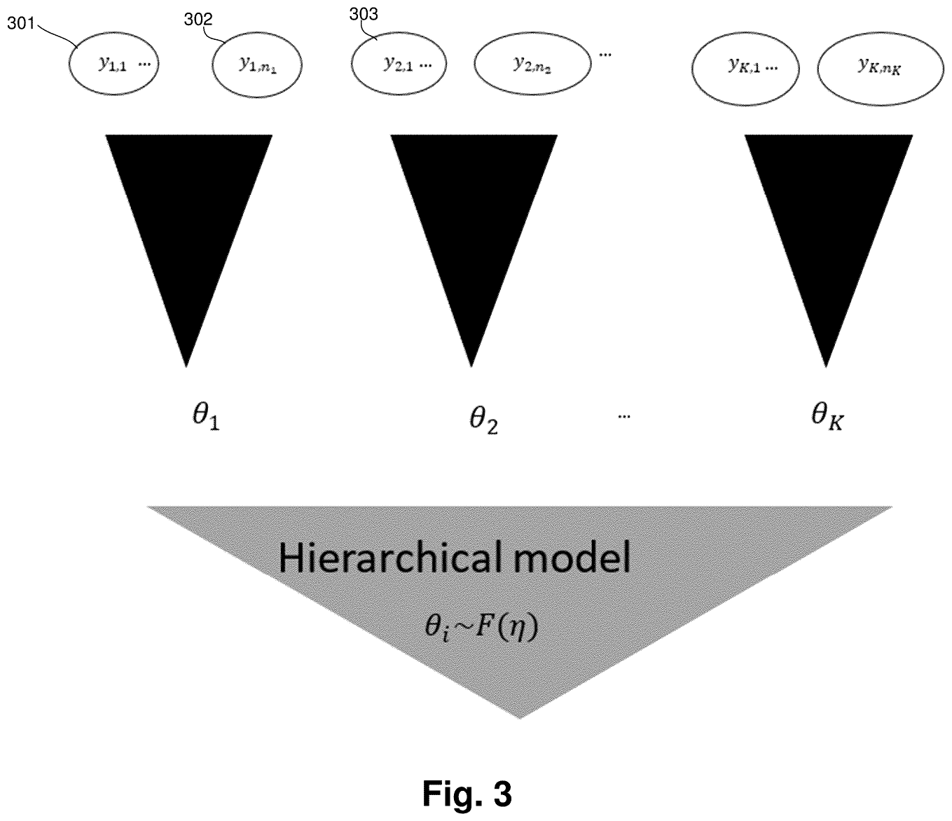

FIG. 3 illustrates a hierarchical model in accordance to embodiments. As shown in FIG. 3, each individual group of observations 301, 302, 303, etc., serves as a basis for estimating its own distribution parameter vector et, which are in turn coming from a common distribution F (n) whose parameters are also estimated.

### Perturbation-Based Inventory Allocation Optimization Problem

After the demand model is generated, as disclosed above, embodiments consider a problem of inventory allocation from several warehouses to multiple stores where an assortment is given, and demand distributions are known. Using the demand model, embodiments find the optimal inventory allocation of each product from warehouses to stores to maximize overall revenue subject to inventory and other constraints and stock-out effects during the sales period.

The selling horizon is denoted as T and there are N stores in the system. Embodiments assume that replenishment from the warehouses to the stores is performed only once in the beginning of the season (i.e., one time allocation) the allocated amount is consumed throughout the horizon and there is no inventory transshipment between store inventories. The demand forecast at store i in period t is denoted as D_{i,t}. The objective is to maximize the expected revenue.

Embodiments assume that the changes in the assortment result in partial demand transference to the newly introduced product items from the existing items as well as from the uncaptured part of the market. For example, a t-shirt assortment that includes only orange and red t-shirts may result in a total demand of 8 t-shirts. When additional blue t-shirts are added in the assortment, the result in decreasing demand for the orange and red t-shirts but an increasing in the total demand to 9 t-shirts. Embodiments also assume that the reverse is true, such as demand for the “blue” t-shirt increases after the stock-out of the “orange” t-shirt while some demand is lost and the total demand is decreased.

### Problem Formulation

Embodiments assume that there are K products in the assortment. Decision variables of the problem are x_{j,i,k} for i∈[N] and k∈[K] which are allocated inventory amounts to the store i for product k from the warehouse j∈[J]. The K×N×J decision variables are denoted by X.

Given selling prices pₖ, the expected revenue can be defined as:

$$r ( X ) = 𝔼 [ {\sum }_{i = 1}^{N} {\sum }_{k = 1}^{K} {p}_{k} min ( {\sum }_{j ∈ J} {x}_{j , i , k} , {\sum }_{t = 1}^{T} {D}_{i , k , t} ( {A}_{it} ) ) ] .$$

This revenue optimization model is agnostic of the demand model if the demand model accounts for the current assortment of products Aᵢₜ at store i at time t. Therefore, one embodiment uses the demand model disclosed above. It is assumed that the demand distribution for a particular product D_{i,k,t} is independently and identically distributed given the offered assortment, which does not restrict application of this approach in most of the business cases. Note that for assortments change (i.e., when one product depletes and is not offered anymore) demand rates of the products will also change due to demand transference as determined by the demand model. If the inventory amount product k available at warehouse j is denoted by Iⱼₖ, then the formulation of the constrained optimization problem can be stated as:

$$\begin{matrix}U = {max}_{X} 𝔼 [ {\sum }_{i = 1}^{N} {\sum }_{k = 1}^{K} {p}_{k} min ( {\sum }_{j ∈ J} {x}_{j , i , k} , {\sum }_{t = 1}^{T} {D}_{i , k , t} ) ] \\ \begin{matrix} s . t . {\sum }_{i = 1}^{N} {x}_{j , i , k} \leq {I}_{jk} & ∀ k ∈ [ K ] , ∀ j ∈ [ J ]\end{matrix}\end{matrix} \qquad ( 4 )$$

When there is more than enough inventory for each product (i.e., let d_{i,k,t} be demand realization, a more than enough inventory supply satisfies that Σₜ Σᵢ d_{i,k,t}≤Iₖ, ∀ₖ∈[K], with high probability) the problem becomes trivial, since, all the demand can be readily satisfied. However, when at least one source fails to satisfy its total demand, the allocation schema becomes a hard combinatorial problem. In particular, embodiments assume that when a product runs out of inventory at a store, the total demand for that store decreases and demand for other products either stays the same or increases. Therefore, depletion times of products at each store are critical for maximizing revenue.

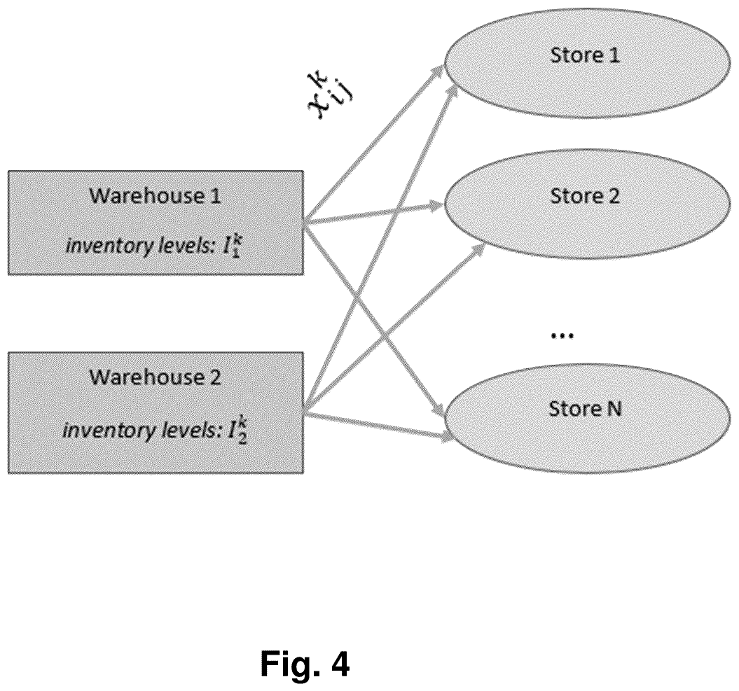

FIG. 4 illustrates the allocation problem in accordance to embodiments.

### Gradient Estimation

Gradient estimation, or a gradient based-search, is to use the gradient of the objective function (i.e., the function that needs to be optimized) to iteratively update the decision variables until an optimal solution is found. In embodiments, the objective function represents the revenue that can be generated by adjusting the pricing and/or inventory levels of the product. The decision variables in embodiments are the inventory levels themselves (i.e., no pricing), which can be adjusted to maximize the revenue.

The perturbations to inventory levels affect overall revenue. To simplify for the purposes of this disclosure, the store and warehouse indices can be dropped and instead denoted by a single-indexed variable xx the total amount of product k allocated to a particular store from all warehouses. In other words, xₖ=Σ_{j∈j}x_{j,i,k}.

Denoting the expected depletion of product k by τₖ results in:

$${τ}_{k} = \frac{{x}_{k}}{𝔼 [ {D}_{k} ]} ,$$

if k is the first product that depletes in the store.

Without loss of generality, assume that products are ordered by their expected depletion times (i.e. τ₁≤τ₂≤ . . . ≤τ_{K}). Hence, product 1 will be depleted first. If Δx₁ inventory is injected to the store, the change in the depletion time can be written as:

$$Δ {τ}_{1} = \frac{Δ {x}_{1}}{𝔼 [ {D}_{1} ]} .$$

Moreover, injection for product 1 will also change depletion times of other products. Denote the demand rate between τⱼ₋₁ and τⱼ for product k by Dₖ(τⱼ). Then,

$${x}_{2} = {τ}_{1} {D}_{2} ( {τ}_{1} ) + ( {τ}_{2} - {τ}_{1} ) {D}_{2} ( {τ}_{2} ) ,$$

which gives:

$${τ}_{2} {D}_{2} ( {τ}_{2} ) = {x}_{2} + {τ}_{1} ( {D}_{2} ( {τ}_{2} ) - {D}_{2} ( {τ}_{1} ) ) ,$$

$$and {τ}_{2}^{′} {D}_{2} ( {τ}_{2} ) = {x}_{2} + {τ}_{1}^{′} ( {D}_{2} ( {τ}_{2} ) - {D}_{2} ( {τ}_{1} ) ) ,$$

where τ₁′ and τ₂′ are the new depletion times after the injection. Taking the difference gives:

$$Δ {τ}_{2} = Δ {τ}_{1} \frac{{D}_{2} ( {τ}_{2} ) - {D}_{2} ( {τ}_{1} )}{{D}_{2} ( {τ}_{2} )} .$$

### Similarly:

$${τ}_{3} {D}_{3} ( {τ}_{3} ) = {x}_{3} + {τ}_{1} ( {D}_{3} ( {τ}_{2} ) - {D}_{3} ( {τ}_{1} ) ) + {τ}_{2} ( {D}_{3} ( {τ}_{3} ) - {D}_{3} ( {τ}_{2} ) )$$

$$and {τ}_{3}^{′} {D}_{3} ( {τ}_{3} ) = {x}_{3} + {τ}_{1}^{′} ( {D}_{3} ( {τ}_{2} ) - {D}_{3} ( {τ}_{1} ) ) + {τ}_{2}^{′} ( {D}_{3} ( {τ}_{3} ) - {D}_{3} ( {τ}_{2} ) ) .$$

### Then:

$$\begin{matrix}Δ {τ}_{3} = Δ {τ}_{1} \frac{{D}_{3} ( {τ}_{2} ) - {D}_{3} ( {τ}_{1} )}{{D}_{3} ( {τ}_{3} )} + Δ {τ}_{2} \frac{{D}_{3} ( {τ}_{3} ) - {D}_{3} ( {τ}_{2} )}{{D}_{3} ( {τ}_{3} )} \\ = {Δτ}_{1} \frac{{D}_{3} ( {τ}_{2} ) - {D}_{3} ( {τ}_{1} )}{{D}_{3} ( {τ}_{3} )} + Δ {τ}_{1} \frac{{D}_{2} ( {τ}_{2} ) - {D}_{2} ( {τ}_{1} )}{{D}_{2} ( {τ}_{2} )} \frac{{D}_{3} ( {τ}_{3} ) - {D}_{3} ( {τ}_{2} )}{{D}_{3} ( {τ}_{3} )}\end{matrix} .$$

Note that demand rates are known and according to assumption in embodiments, Dₖ(τₘ)≥Dₖ(τₙ) for any k and m>n. Thus, Δτₖ for all k∈[K] can be computed efficiently by sequentially solving the equations for τₖ and τ_{K}′ as above.

Therefore, the change in revenue of product m at store i due to the injection of product k, Δxₖ is:

$$Δ {r}_{i}^{m} = {\sum }_{ℓ = k}^{K} Δ {τ}_{ℓ} {p}_{m} {D}_{m} ( {τ}_{ℓ} )$$

Which allows for the efficient computation of the entire store revenue gradient ∂Rᵢ/∂xₖ components as the changes in the product revenues have linear dependence on the amount of any other product changes within a small magnitude of change:

$$\frac{\partial {R}_{i}}{\partial {x}_{k}} = \frac{{\sum }_{m = 1}^{K} Δ {r}_{i}^{m}}{Δ {x}_{k}} \qquad ( 5 )$$

Embodiments determine a break-even point. It is determined that the store is injected with inventory as much as the break-even point when Δτ₁-Δτ₂=τ₁−τ₂, i.e. the level that changes the ordering of depletion times. Then, the break-even depletion time can be determined by:

$$Δ {τ}_{1}^{BE} = ( {τ}_{2} - {τ}_{1} ) \frac{{D}_{2} ( {τ}_{2} )}{{D}_{2} ( {τ}_{1} )} ,$$

and it can be used to find the break-even injection amount, as:

$$\begin{matrix}Δ {x}_{1}^{BE} = Δ {τ}_{1}^{BE} {D}_{1} ( {τ}_{1} ) \\ = ( {τ}_{2} - {τ}_{1} ) {D}_{1} ( {τ}_{1} ) \frac{{D}_{2} ( {τ}_{2} )}{{D}_{2} ( {τ}_{1} )}\end{matrix} .$$

Since the demand distributions are known, Δxᵢ^{BE} for all i∈[N] can also be computed efficiently. The break-even points set the limits of the gradient-based search steps. The break-even points also mark the points where the change of gradient occurs depending on the direction of the allocation, that is, on whether the amount of the allocated product is increased or decreased.

### Solving the Optimization Problem

The optimization problem (4) is solved in embodiments by using Lagrangian relaxation approach by introducing dual variable λⱼₖ for each inventory capacity constraint corresponding to each product k and warehouse j combination. These variables are interpretated as the marginal cost of the binding constraint in the following way. λⱼₖ expresses the marginal improvement of the revenue objective of (4) per additional unit of product k inventory added at warehouse j.

The Lagrangian relaxation of problem (4) can then be written as:

$${max}_{X} R ( X ) = E [ {\sum }_{i = 1}^{N} {\sum }_{k = 1}^{K} {p}_{k} min ( {\sum }_{j ∈ J} {x}_{j , i , k} , {\sum }_{t = 1}^{T} {D}_{i , k , t} ) ] + {\sum }_{j ∈ J} {\sum }_{k = 1}^{K} {λ}_{jk} ( {I}_{jk} - {\sum }_{i = 1}^{N} {x}_{j , i , k} ) \qquad ( 6 )$$

Using the definition of λⱼₖ and equation (5) for the change in revenue due to the injection of product k into store i, it can be shown that for the given values of x_{j,i,k} variables, the dual costs are determined as:

$${λ}_{jk} = {max}_{i ∈ N} \frac{\partial {R}_{i}}{\partial {x}_{j , i , k}} \qquad ( 7 )$$

The equation (7) for λⱼₖ reflects the revenue-maximizing allocation of the inventory aimed at increasing the stock at the store with highest marginal revenue.

The algorithm aims to optimize the allocation amounts and dual variables simultaneously. For the dual variables, gradient descent is used since the function is convex for lambda; for the allocation the objective function is concave as long as the depletion sequence does not change. Therefore, according to gradient signs, the allocation amounts are increased or decreased until their break-even points. Then the gradients are recomputed, and the process reiterates. The algorithm stops if the objective does not improve for some consecutive rounds.

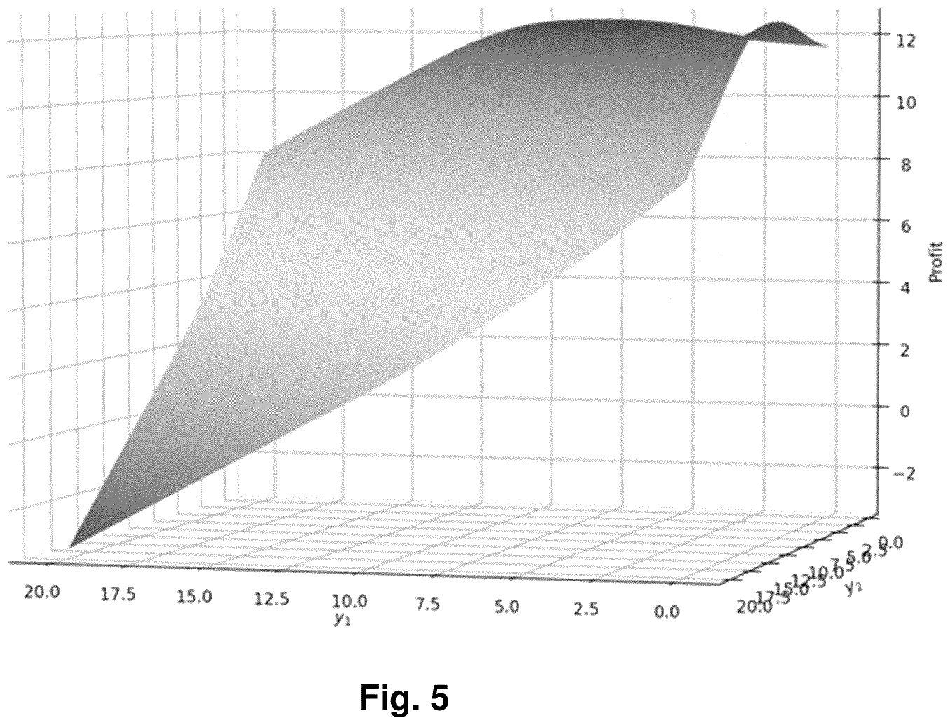

FIG. 5 illustrates an example of solutions for the allocation optimization problem for three products by changing inventory levels of two products in accordance to embodiments. As shown in FIG. 5, the problem may have several local maxima. Therefore, in this example, the algorithm is run several times using randomly selected starting points.

### Modification to Account for Shipment and Handling Costs

Embodiments can be easily modified to account for the shipping costs of each product from the warehouse to the store assuming the cost is charged per unit of product shipped. Specifically, let cⱼᵢₖ denote the shipment cost of one unit of product k between warehouse j and store i. Then the optimization problem (6) becomes the profit P(X) maximization problem:

$${max}_{X} P ( X ) = E [ {\sum }_{i = 1}^{N} {\sum }_{k = 1}^{K} {p}_{k} min ( {\sum }_{j ∈ J} {x}_{j , i , k} , {\sum }_{t = 1}^{T} {D}_{i , k , t} ) ] + {\sum }_{j ∈ J} {\sum }_{k = 1}^{K} {λ}_{jk} ( {I}_{jk} - {\sum }_{i = 1}^{N} {x}_{j , i , k} ) - {\sum }_{ijk} {c}_{jik} {x}_{j , i , k} \qquad ( 8 )$$

With the gradient becoming:

$$\frac{\partial {P}_{i}}{\partial {x}_{j , i , k}} = \frac{{\sum }_{m = 1}^{K} Δ {r}_{i}^{m}}{Δ {x}_{j , i , k}} - sgn ( {x}_{j , i , k} ) {c}_{jik}$$

and Lagrangian multiplier

$${λ}_{jk} = {max}_{i ∈ N} ( \frac{\partial {R}_{i}}{\partial {x}_{j , i , k}} - {c}_{jik} )$$

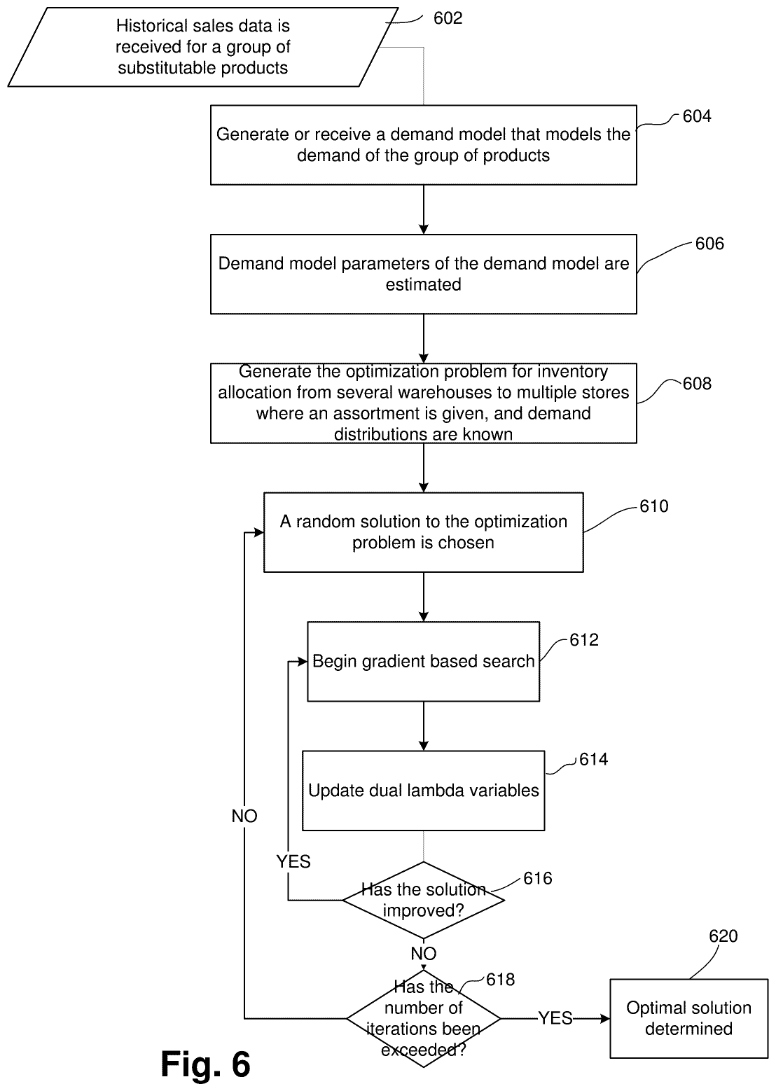

FIG. 6 is a flow diagram of the functionality of inventory allocation optimization module 16 of FIG. 2 in accordance with one embodiment. In one embodiment, the functionality of the flow diagram of FIG. 6 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 602, historical sales data is received for a group of substitutable products. The sales data is generated from multiple retail stores, such as what is obtained from POS 100 of FIG. 2. Each retail store is provided inventory of the multiple products as an assortment of products from one or more of a set of warehouses.

At 604, a demand model is generated (or received) that models the demand of the group of products. The demand model includes a coefficient expressing change in demand due to product cannibalization caused by change in assortment.

At 606, demand model parameters of the demand model are estimated. In embodiments, HHMC or other MCMC model/method is used to estimate the demand parameters.

At 608, the optimization problem for inventory allocation from several warehouses to multiple stores where an assortment is given, and demand distributions are known, is generated (or received). In one embodiment, equation (4) above is used for the optimization problem. The optimization problem includes decision variables, which are different possible inventory levels, which include different possible assortments of the group of products.

At 610, in order to solve the problem, a random solution to the optimization problem of 608, or a “cold start” is chosen as the starting point. As a “cold start”, a starting solution is generated by generating initial inventory allocations to each location by randomly sampling them from normal distributions centered around their expected demands. Alternatively, a “warm start”, or user-provided initial solution can be used.

At 612, a gradient-based search begins. Embodiments first determine the gradient of the objective function (i.e., revenue) with respect to the decision variables (i.e., inventory levels). This gradient provides information about the direction and magnitude of the steepest ascent or descent of the objective function. Next, this gradient information is used to update the decision variables. This can be done by taking a step in the direction of the gradient (if the objective function is being maximized) or in the opposite direction (if the objective function is being minimized). The size of the step is determined by a learning rate, which controls the speed at which the algorithm converges to the optimal solution.

At 614, to solve a relaxed problem, or Lagrangian dual problem, the dual lambda variables (i.e., λⱼₖ for each inventory capacity constraint corresponding to each product k and warehouse j combination) are updated.

In the Lagrangian dual problem, lambda (also known as the Lagrange multiplier or dual variable) is a scalar parameter that is used to enforce the constraints of the original optimization problem.

The Lagrangian dual problem involves taking the Lagrangian of the original problem, which is a function that incorporates both the objective function and the constraints of the problem, with each constraint multiplied by a Lagrange multiplier. The Lagrangian dual problem is then formed by minimizing this Lagrangian function with respect to the decision variables, while maximizing it with respect to the Lagrange multipliers.

Lambda represents the value of the Lagrange multiplier associated with a particular constraint. The value of lambda is such that it satisfies the constraint, and it is found by solving the Lagrangian dual problem. The optimal value of lambda can be used to obtain information about the original optimization problem, such as the optimal value of the objective function or the sensitivity of the solution to changes in the constraints.

For the Lagrangian dual problem, its decision variables (i.e., lambdas) are the dual variables. In embodiments, the lambdas are the shadow costs of the main optimization problem, namely they can be interpreted as the cost of usage of warehouse inventories at particular stores (i.e., λⱼₖ: cost of allocation of one unit of inventory of product k from warehouse j).

At 616, it is determined if the solution to the problem has improved by comparing the total expected revenue of the new solution (new) and the old solution (old).

If yes at 616, functionality continues at 612.

If no at 616, at 618 it is determined if the number of predetermined iterations has been exceeded. In one embodiment, the number of iterations is approximately 100 iterations. In other embodiments, a user-provided time limit can be used as a stopping criterion. If no at 618, functionality continues at 610. If yes at 618, the functionality ends and the current solution to the problem at 620 is the determined optimized solution. The solution specifies the optimal assortment of products that are shipped from each of the warehouses to each of the stores.

The functionality of FIG. 6, for a multi-warehouse, multi-store model for multi-product assortments, includes a gradient calculation for allocation amounts, an application of gradient descent (until break-even points, determining the direction using gradient signs) due to the characteristic properties of the problem, and updating parameters using gradient descent.

In embodiments, as part of the solution, an inventory electronic signal is generated that specifies that amount of inventory that should be transported from each warehouse to each store. The signal can be received by a fully automated system that automatically transports the inventory, using automated inventory moving systems and automated transportation mechanisms, such as self-driving trucks.

### IoT and GPS Tracking

As disclosed, embodiments cause inventory to be transported from each warehouse to each store. Therefore, embodiments further includes the need to determine available inventory, as well as determining when the inventory was actually delivered to the store. Therefore, in embodiments, inventory items as well as transportation related items are tracked. One embodiment uses Global Positioning System (“GPS”) or Internet of Things (“IoT”) based sensors attached to the vehicle and/or inventory in order to generate tracking based features used in embodiments. One embodiment uses a system such as the “Fleet Monitoring Cloud Service” from Oracle Corp. for creating and monitoring trips (i.e., “fleet management”), including inventory both in transit and in warehouses and other location.

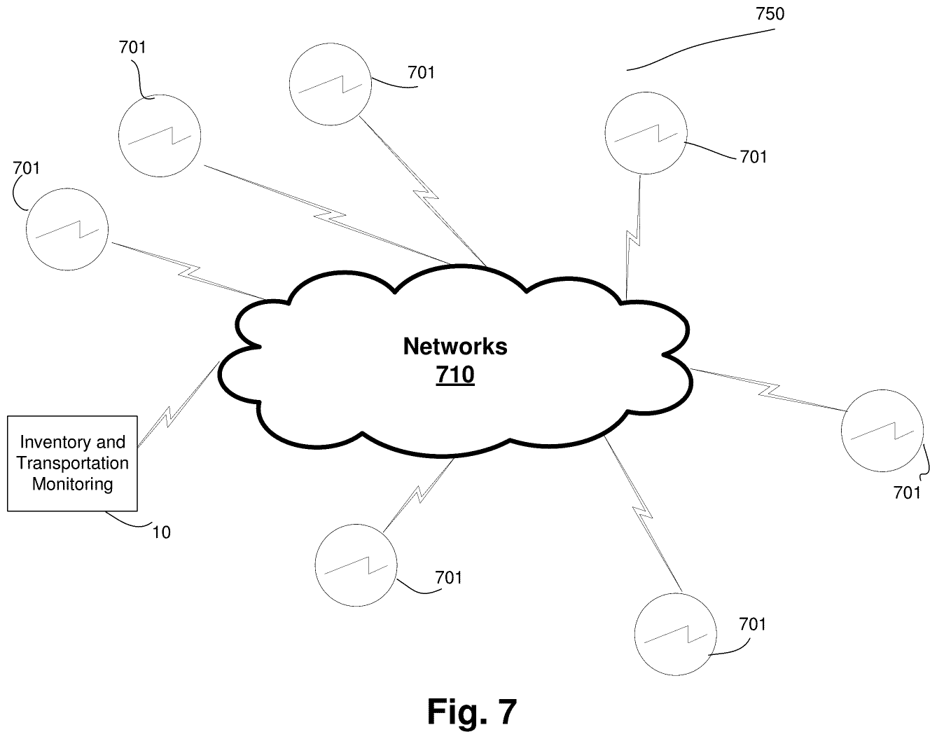

FIG. 7 is an overview diagram of elements of an inventory and transportation monitoring network/system 750 that can implement embodiments of the invention and is included in the functionality of system 10 of FIG. 2. Network 750 includes multiple sensors 701 that form a sensor network 750 in combination with one or more networks 710. Each of sensors 701 can be considered an IoT device with the associated processing and communication capabilities. System 750 may include a relatively large number of sensors 701. For example, for a fleet of “trucks” that are being monitored, each portion of the truck may include a sensor (e.g., the actual truck body and the one or more trailers that are being pulled by the truck, and each inventory item that is loaded into each of the trailers).

An IoT device can be any device that has a sensor attached to it and can transmit data from one object to another or to people with the help of Internet. IoT devices include wireless sensors, software, actuators, and computer devices. They are attached to a particular object that operates through the Internet, enabling the transfer of data among objects or people automatically without human intervention. Each of sensors 701 can include a processor/controller, and a communication interface that uses protocols such as Modbus, Zigbee, or proprietary protocols, to connect to an Edge Gateway.

Network 750 may be used for a variety of purposes, such as, for example, in the transportation industry, where vehicle fleet management is aided by the continuous acquisition of data by sensors that are attached to vehicles. In this embodiment, sensor network 750 may acquire data that may be monitored and processed for such purposes as aiding vehicle maintenance, optimizing vehicle routes, promoting driver safety, etc. Each of sensors 701 communicate, wirelessly or wired, through one or more networks 710. Networks 710 include the Internet, but may also include private on-premise networks that ultimately interface with the Internet as well as any other type of network that allows sensors 701 to communicate.

An inventory and transportation monitoring server 10 is coupled to networks 710 to send and receive data from sensors 701. Inventory and transportation monitoring server 10, as part of system/server 10 of FIG. 2, inventory levels and inventory tracking information.

Embodiments include functionality that is included in a fleet monitoring system that monitors entities including trips, shipments, vehicles, equipment in vehicles, ship-orders, ship-units or packages, ship-items, and the drivers assigned to a trip. The “trip” is a collection of goods that is being transported, has been, or needs to be transported from one geographic location to another. The trip also encompasses the route defined for the movement of the goods.

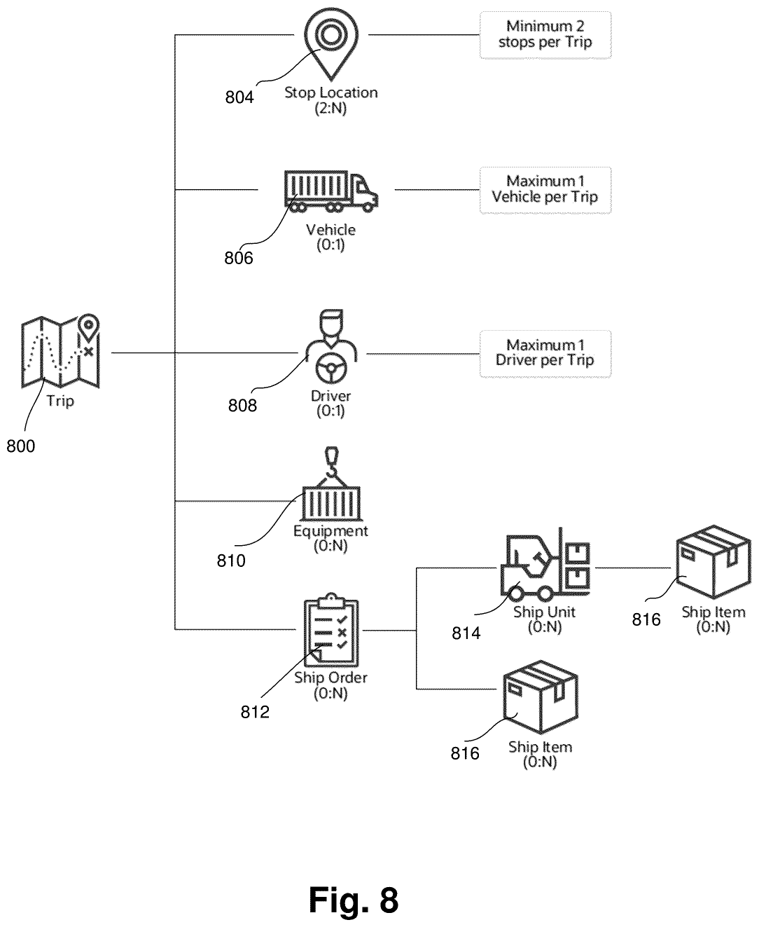

FIG. 8 illustrates the entities/sub-entities that may form a planned trip 800 in accordance to embodiments. In addition to the start location and the final destination location, not shown, sub-entities include stop locations 804, which are the intermediate stops between the source and destination. They are either delivery points or pick up points. Sub-entities further includes a vehicle 806, which is a conveyance such as a truck or a car for transporting inventory from a source location to a stop location.

Sub-entities further includes a driver 808, which is the driver assigned to the trip. Sub-entities further includes equipment 810, which represents any method of storage or transport used for the movement of goods in a trip from one location to another, such as, a trailer, container, flatbed, or a tank, and so on. It can have sensors/trackers attached for measuring attributes including GPS, temperature, humidity, shock, tilt, pressure, and so on.

Sub-entities further include ship-orders 812, which are part of the inventory metadata that contains order information required for transportation of goods from one location to another in a trip. Sub-entities further includes ship-units 814 that are a transportation handling unit that is used to facilitate ease of transportation in a trip. These can be wooden or metallic pallets, boxes, cartons, automotive racks, and so on. A ship-order can contain one or more ship-units. Sub-entities further include ship-items 816 that are an individual trackable inventory item or items that is being transported and monitored in a trip. It can belong to a ship-unit 814 or can be independent of ship-units 814.

Each of the items and sub-items shown in FIG. 8 can be tracked using a corresponding sensor 701 (e.g., an IoT sensor) that transmits the location of the item, and other information if needed, at predetermined time intervals, in the form of messages. The messages are received by inventory and transportation monitoring server 10.

### Sensor Gateway

In embodiments where there are a large number of IoT sensors 701, and/or some sensors are used for monitoring as disclosed above, while other sensors are used for other types of functionality, a gateway between the sensors and the cloud is implemented. Examples of other types of functionality for sensors 701 include measurement of temperature, humidity, CO2 levels, GPS, water level, water presence, electrical current/voltage, light, presence, etc. Small sensors or legacy devices can directly transmit their data to a nearby gateway instead of to the cloud, reducing their power consumption and increasing the sensors' battery life.

The gateway communicates with different types of sensors/devices using different protocols and then sends the data to a cloud service using a standard protocol. The gateway acts as a filter for the huge amount of data sent by the devices, processing the data and sending only relevant information to the cloud. Therefore, the processing and storage services is utilized optimally so that the need for processing and storage is reduced. Further, the response time for the sensors is considerably reduced. The nearby gateway receives the sensor data, processes it, and sends relevant commands back to the sensors. Further, gateways are highly secure and they also help secure the sensors and devices that are connected to them.

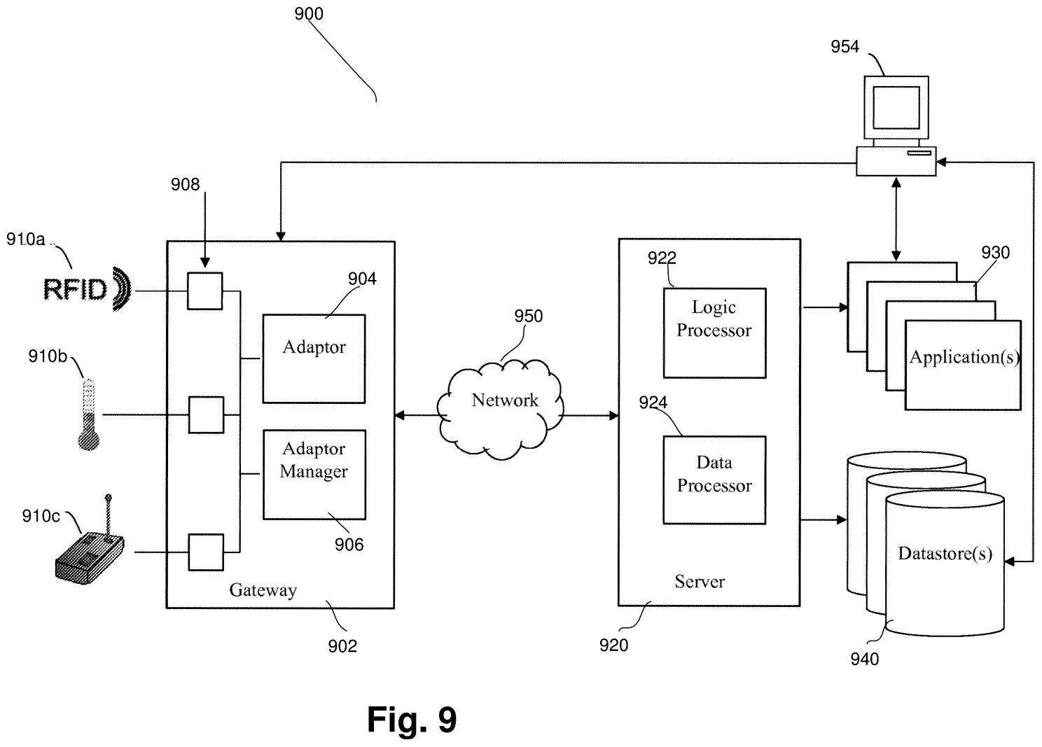

FIG. 9 is a block diagram of a gateway architecture 900 in accordance to embodiments of the invention. Architecture 900 permits effective integration between the systems in the operations technology portion and the systems in the information technology portion of the environment. Architecture 900 generally includes a gateway portion 902 having front-end data collection logic, and a server portion 920 to perform back-end processing of the collected data. To handle many different device/sensor types (including IoT sensors 501) and to provide the ability to handle high numbers of units being deployed in the field, embodiments provide a robust platform for handling issues such as: (a) sensor definition; (b) sensor management; (c) data capture; (d) data processing; (e) data transfer; (f) data storage; (g) analysis; and/or (h) visualizations. This architecture provides a framework for interfacing with any type of local device that may be deployed at a client site, and to allow data captured from those devices to be sent to a remote server, and to have the collected data be both locally and remotely programmatically processed. Gateway architecture 900, in general, can function as a sensor message receiving module that receives sensor messages.

Gateway 902 includes a sensor management module that handles the sensor code (e.g., that is implemented as custom code, such as Java code, specific to each sensor hardware). This module captures the sensor data in a generic way so that any type of data can be used. The gateway locally caches data so it can be pre-processed locally and no data is lost when there is no network connectivity. The data preprocessor performs actions such as data filtering using a set of rules. The system throttles the data so that data rates do not overwhelm the capabilities of the client gateway or the network. An internal data store may be included to store data in a platform-agnostic way. A data transfer module is employed to build the data for transmission. The system permits client gateways to talk to each other so as to establish a mesh network ensuring resiliency and connectedness.

In general, gateway 902 performs data acquisition and management of local devices 910a-c. The local devices 910a-c may include any type of equipment that can be suitably managed by architecture 900. For example, any number of sensors may be embedded within the local equipment at various sites. Examples of such sensors include RFID sensors at device 910a, temperature sensors at device 910b, and other types of smart devices, beacons, and/or machines at device 910c (including IoT sensors 501).

Local devices 910a-c can be configured to send data at regular intervals to gateway 902. Such data may include information to be captured from the local devices. For example, information that may be captured include operating conditions, metrics, pressure, vibration, temperature, and/or flow rate.

In additional to using sensor data for fleet management, as disclosed above, other examples of the uses for sensor data may include: (a) handling perishable goods, where the system continuously monitors the temperature, humidity and location of goods as they travel through the supply chain, where by monitoring these critical factors and taking quick action on alerts, one can significantly reduce the spoiled goods and as a result increase revenue; (b) managing heavy machinery, by tracking the locations of a company's equipment along with environment conditions and operating metrics of the equipment, thereby ensuring that the equipment is being operated properly, preventing machine failures, and ensuring that the equipment is being properly used to the organization's goods and services; and (c) providing product support, where products that are sold could communicate back to the maintenance organization with current status, diagnostic information, and available quantity of consumables, and where the provided information helps to deliver a better quality of service to customers by discovering potential failures before they impact the customer and also increase revenue through expanded service offerings and replenishment of consumables.

Gateway 902 includes an adaptor component 904 and an adaptor manager 906. Adaptor component 904 (also referred to herein as an “IoT adaptor”) manages the gateway's interaction with local devices 910a-c, and may include device-specific code components 908 to perform its processing with local devices 910a-c. Adapter manager 906 (also referred to herein as an “IoT adaptor manager”) is used to manage the operations, versioning, and/or provisioning of local devices 910a-c and adaptor component 904. In some embodiments, gateway 902 processes incoming data with local analytics (e.g., to analyze operating conditions and to identify fluctuations). To the extent necessary, alerts and data readings can be sent in real-time.

The data collected by gateway 902 are sent over a network 950 to server 920. Server 920 efficiently receives data from potentially a multitude of client gateways. The server module parses the data and caches it locally to expedite data capture. Pre-processing of the data may be performed for filtering, applying simple or complex script-based rules, etc. The data may be stored in an internal database. The persisted data can be forwarded to a corporate, generic table store. The server module may also take action based on the result of rules applied on the data, such as calling a web service, invoking further more complex rules, sending control data back to devices, etc. A generic table format can be used to store the sensor data within the enterprise application ecosystem. Keeping the relevant data within the ecosystem allows the use of standard tools in the enterprise application, such as reporting tools and form design tools. This means that users can use their pre-existing tools and systems to process the data from the operations technology (“OT”) side, which allows the user to use systems which they are well-versed in using to report on and add intelligence to the data that is captured. An open interface (e.g., a RESTful interface) enables the captured data to be enquired and allows the development of rich, responsive, up-to-date client interfaces.

At server 920, a logic processor 922 (also referred to herein as an “IoT logic processor”) and a data processor 924 (also referred to herein as an “IoT data processor”) are provided to implement analysis and alert processing. These components may include operations technology and industry-specific rules and scripts.

Server 920 may communicate with one or more applications 930. Such applications 930 may include, for example, functionality to implement inventory management, quality management, condition-based maintenance, and/or provide a visualization portal, as well as functionality of FIGS. 3-4 for sale order fulfillment predictions. Examples of these applications include, for example, Emergency Shutdown (“ESD”) systems, Supervisor Control and Data Acquisition (“SCADA”) systems, data analytics tools, BI (“business intelligence”) tools, customer relationship management (“CRM”) products, enterprise resource planning (“ERP”) products, enterprise marketing products, financials applications, and/or procurement applications. The application products are hosted on computing hardware operated by the cloud provider.

Server 920 may also manage the storage of the collected data into one or more datastores 940. Datastore 940 includes any combination of hardware and software that allows for ready access to the data that is located at a computer readable storage device. For example, datastore 940 could be implemented as computer memory operatively managed by an operating system. The data in datastore 940 could also be implemented as database objects and/or files in a file system.

One or more users may exist at one or more user stations 954 that interact with the architecture 900. User station 954 includes any type of computing station that may be used to operate or interface with architecture 900. Examples of such user stations include, for example, workstations, personal computers, mobile devices, or remote computing terminals. The user station comprises a display device, such as a display monitor, for displaying a user interface to users at the user station. The user station also comprises one or more input devices for the user to provide operational control over the activities of the architecture 900, such as a mouse or keyboard to manipulate a pointing object in a graphical user interface to generate user inputs.

Either server 920 or the user at user station 954 may provide control signals to gateway 902 to control the operation of the gateway 902 and/or the local devices 910a-c. The control signals may be used to control any operation necessary at the gateway and/or local device 910a-c, including for example, to update and provision control software on the gateway and/or to control operation of the local device.

In embodiments, the generated sensor messages are generated as a specialized data structure that includes attributes of sensors, vehicles, etc. In embodiments, the specialized data structure is in the form of an electronic document (e.g., an XML document) and is stored in database 17. A “data structure,” as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

As disclosed, embodiments are directed to a product assortment optimization problem, which has a complex structure that makes it computationally intractable to solve to optimality. Embodiments iteratively improve the solution by modifying the product allocations at each store while considering the assortment effects and demand transference due to stockouts. Embodiments, in connection with the expected stockout times of products, observe that the revenue function is a piecewise concave function, and it preserves its concavity if the order of depletion times does not change. Therefore, embodiments leverage this fact by determining the break-even points of inventory levels at which the order of depletion times changes. Then, embodiments determine the sign of the derivative of the revenue function with respect to the inventory level of each product. Embodiments perform inventory injections or inventory reductions until break-even points depend on the sign of the derivative. In this way, the piecewise linear concave structure is used efficiently. After changes in inventory levels, a new iteration starts with the computation of the new break-even points.

Embodiments address a multi-warehouse inventory allocation process aimed at maximizing revenue while considering the available inventory at each warehouse and assortment of products. This problem has a complex structure that makes it computationally intractable to solve to optimality. Embodiments iteratively improve the solution by modifying the product allocations at each store while considering the assortment effects and demand transference due to stock outs. Embodiments, in connection with the expected stockout times of products, observe that the revenue function is a piecewise concave function, and it preserves its concavity if the order of depletion times does not change. Therefore, embodiments leverage this fact by determining the break-even points of inventory levels at which the order of depletion times changes. Then, embodiments determine the sign of the derivative of the revenue function with respect to the inventory level of each product. Embodiments perform inventory injections or inventory reductions until break-even points depend on the sign of the derivative. In this way, the piecewise linear concave structure is used efficiently. After changes in inventory levels, a new iteration starts with the computation of the new break-even points. This process involves two stages, the first of which employs a Hierarchical Hamiltonian Monte-Carlo (“HHMC”) approach for demand model parameter estimation using historical observations. In the second stage, a novel iterative model incorporates Lagrangian Multipliers to penalize violations of inventory constraints, enabling efficient inventory allocation optimization across multiple stores and multiple warehouses.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of optimizing inventory assortment and allocation of a group of products, wherein the group of products are allocated from a plurality of different warehouses to a plurality of different retail stores, the method comprising:
receiving historical sales data for the group of products;
estimating demand model parameters of a demand model that models a demand of the group of products;
solving an optimization problem for the inventory assortment and allocation of the group of products, the optimization comprising a plurality of decision variables, an objective function, and a corresponding Lagrangian relaxation, the solving to generate an optimized solution comprising:
determining a gradient of the objective function with respect to the decision variables;
updating the decision variables based on a direction of the gradient; and
updating dual lambda variables of the Lagrangian relaxation.

2. The method of claim 1, the solving further comprising:
generating a randomized optimized solution before the determining the gradient.

3. The method of claim 2, the solving further comprising:
when the optimized solution improves the objective function, repeating the determining the gradient of the objective function, the updating the decision variables, and the updating dual lambda variables.

4. The method of claim 3, the solving further comprising:
when the optimized solution does not improve the objective function, determining if a number of iterations has been exceeded;
when the number of iterations has been exceeded, the optimized solution is output as a new inventory assortment and allocation of the group of products;
when the number of iterations has not been exceeded, repeating the generating the randomized optimized solution, the determining the gradient of the objective function, the updating the decision variables, and the updating dual lambda variables.

5. The method of claim 1, wherein the estimating demand model parameters of the demand model comprises using Hierarchical Hamiltonian Monte-Carlo.

6. The method of claim 1, wherein the plurality of decision variables comprises inventory levels of the group of products, and the objective function comprises revenue.

7. The method of claim 6, wherein the inventory levels are determined by attaching Internet of Things (IoT) sensors to the inventory and tracking messages generated by the IoT sensors.

8. The method of claim 1, wherein the optimized solution comprises an electronic inventory electronic signal that is adapted to be an automated system to cause the group of products to automatically be transported from the warehouses to the stores.

9. A computer-readable medium having instructions stored thereon, when executed by one or more processors, cause the processors to optimize an inventory assortment and allocation of a group of products, wherein the group of products are allocated from a plurality of different warehouses to a plurality of different retail stores, the optimizing comprising:
receiving historical sales data for the group of products;
estimating demand model parameters of a demand model that models a demand of the group of products;
solving an optimization problem for the inventory assortment and allocation of the group of products, the optimization comprising a plurality of decision variables, an objective function, and a corresponding Lagrangian relaxation, the solving to generate an optimized solution comprising:
determining a gradient of the objective function with respect to the decision variables;
updating the decision variables based on a direction of the gradient; and
updating dual lambda variables of the Lagrangian relaxation.

10. The computer-readable medium of claim 9, the solving further comprising:
generating a randomized optimized solution before the determining the gradient.

11. The computer-readable medium of claim 10, the solving further comprising:
when the optimized solution improves the objective function, repeating the determining the gradient of the objective function, the updating the decision variables, and the updating dual lambda variables.

12. The computer-readable medium of claim 11, the solving further comprising:
when the optimized solution does not improve the objective function, determining if a number of iterations has been exceeded;
when the number of iterations has been exceeded, the optimized solution is output as a new inventory assortment and allocation of the group of products;
when the number of iterations has not been exceeded, repeating the generating the randomized optimized solution, the determining the gradient of the objective function, the updating the decision variables, and the updating dual lambda variables.

13. The computer-readable medium of claim 9, wherein the estimating demand model parameters of the demand model comprises using Hierarchical Hamiltonian Monte-Carlo.

14. The computer-readable medium of claim 9, wherein the plurality of decision variables comprises inventory levels of the group of products, and the objective function comprises revenue.

15. The computer-readable medium of claim 14, wherein the inventory levels are determined by attaching Internet of Things (IoT) sensors to the inventory and tracking messages generated by the IoT sensors.

16. The computer-readable medium of claim 9, wherein the optimized solution comprises an electronic inventory electronic signal that is adapted to be an automated system to cause the group of products to automatically be transported from the warehouses to the stores.

17. A system for optimizing an inventory assortment and allocation of a group of products, wherein the group of products are allocated from a plurality of different warehouses to a plurality of different retail stores, the system comprising one or more processors and a storage device that stores instructions that when executed by the processors performs the optimizing comprising:
receiving historical sales data for the group of products;
estimating demand model parameters of a demand model that models a demand of the group of products;
solving an optimization problem for the inventory assortment and allocation of the group of products, the optimization comprising a plurality of decision variables, an objective function, and a corresponding Lagrangian relaxation, the solving to generate an optimized solution comprising:
determining a gradient of the objective function with respect to the decision variables;
updating the decision variables based on a direction of the gradient; and
updating dual lambda variables of the Lagrangian relaxation.

18. The system of claim 17, the solving further comprising:
generating a randomized optimized solution before the determining the gradient.

19. The system of claim 18, the solving further comprising:
when the optimized solution improves the objective function, repeating the determining the gradient of the objective function, the updating the decision variables, and the updating dual lambda variables.

20. The system of claim 19, the solving further comprising:
when the optimized solution does not improve the objective function, determining if a number of iterations has been exceeded;
when the number of iterations has been exceeded, the optimized solution is output as a new inventory assortment and allocation of the group of products;
when the number of iterations has not been exceeded, repeating the generating the randomized optimized solution, the determining the gradient of the objective function, the updating the decision variables, and the updating dual lambda variables.
